(19) United States
(12) Patent Application Publication
(10) Pub. No.: US 2009/0277462 A1
(43) Pub. Date: Nov. 12, 2009

(54) FOAM EARPLUG IN DEFORMABLE SHEATH

(75) Inventors: Sharon R. Garber, Plymouth, MN (US); Michael E. Hamerly, Vadnais Heights, MN (US); Philip G. Martin, Forest Lake, MN (US); Lance E. Behymer, Woodbury, MN (US); Mark K. Nestegard, Mendota Heights, MN (US); Bernard A. Gonzalez, St. Paul, MN (US); Daniel D. Anderson, Minneapolis, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/118,153

(22) Filed: May 9, 2008

(51) Int. Cl. B23P 19/00

(52) U.S. Cl. 128/864; 29/592

(57) ABSTRACT

An earplug system 10a, 10b that includes a foam earplug 12a, 12b and a deformable sheath 14 that individually surrounds at least the body 16 of the foam earplug 12a, 12b in a noncompressed condition. The deformable sheath 14 allows the earplug to be compressed with a person's fingers in the sleeve before being placed within the user's ear. In this manner, the earplug can be inserted into the ear canal without being soiled or otherwise contaminated from a wearer's unclean hands.

The present invention pertains to an earplug system that includes a foam earplug that is disposed in a deformable sheath. The earplug system can be placed between a person's fingers, allowing the foam earplug to be rolled into a compressed pre-insertion condition while still in the sheath.

### BACKGROUND

Foam earplugs have become well accepted for use in providing sound attenuation to people. Such earplugs are generally cylindrical in shape and are somewhat larger in diameter than the human ear canal. The earplugs typically are composed of a foamed polymeric material that has sufficient concentration of plasticizer to enable the earplug to exhibit a reduced recovery rate from a compressed state. To protect the earplugs from contamination until use, the earplugs are typically packaged in pairs in translucent plastic bags or in cardboard pillow-pack containers.

To insert a foam earplug into the ear, the earplug is first removed from the packaging and is compressed by twirling it between the fingers along its lengthwise axis. The compressed earplug is then maneuvered into the ear canal where it can slowly expand until it fills the canal. In this manner, the earplug is able to attenuate noise from the external environment.

Workers who use hearing protection often operate in environments where their hands become dirty. When a worker has dirty hands—for example from grease, dirt, dust, particulates—the worker is hesitant to insert a foam earplug into their ear. The contaminants on the worker's hands can be transferred to the surface of the earplug during the earplug compression step and then can be transferred into the ear canal when the earplug is placed in it. Workers therefore must clean their hands before using foam earplugs to avoid contamination of the ear canal.

To overcome this contamination issue, Dyrud et al. invented (see U.S. Pat. No. 5,609,164) an earplug containment system that eliminated the manual compression step. The Dyrud et al. system included a sleeve into which the foam earplugs were placed in a pre-compressed condition. When disposed in the hollow sleeve, the earplugs would be compressed to a cross-sectional size less than that of an ear canal, but when expanded, the earplugs would have a diameter that was greater than that of the human ear canal. In use, the worker simply removed the compressed earplug from the sleeve and inserted it into their ear canal. The Dyrud et al. system worked well for providing the user with a clean set of earplugs. The system did, however, have one particular drawback: if earplugs were not used in a timely manner, they would tend to adopt the inner diameter of the hollow sleeve. That is, if the earplugs remained in the sleeve for an extended time period, the diameter of the foam earplugs would become less than the diameter of the typical human ear canal.

### SUMMARY OF THE INVENTION

The present invention overcomes the drawback of the Dyrud et al system while also providing the user with clean earplugs that can be inserted into the human ear canal. In so doing, the present invention provides an earplug system that comprises: (a) a foam earplug; and (b) a deformable sheath that individually surrounds at least the body of the foam earplug in a noncompressed condition so as to allow the earplug to be compressed with a person's fingers while in the sleeve and before being placed within the user's ear.

The present invention is beneficial in that the earplug can remain in an expanded condition while in the sheath but also can be compressed by the user just before being inserted into the ear canal. Thus, the earplug is not subjected to a constant compression force that would cause it to adopt a shape or diameter that is less than that of the human ear canal. The present invention also eliminates risk of contaminating the outer surface of the earplug. The invention therefore provides a hygienic yet simple system for protecting the earplug before being compressed and inserted into the ear canal.

### GLOSSARY

“body” means the general portion of the earplug that is fashioned for being disposed in the human ear canal during earplug use;

“compressed” means reduced in size through pressure application;

“deformable” means having the ability to be readily altered in shape by mere finger pressure;

“earplug” means a device that is designed for being inserted into the human ear canal to attenuate sound;

“earplug system” means a combination of parts that have application in the hearing protection field;

“foam earplug” means an earplug that has voids within a solid material to allow at least that body of the earplug to be compressed and then expanded from the compressed condition;

“individually surrounds” and “individually disposed in” means located about a single one (or a portion thereof)—not two or more—of the items in question;

“plastic” and “polymeric” means comprising polymers mainly, along with other possible ingredients;

“noncompressed condition” means not compressed from its relaxed state;

“object” means a tangible thing;

“separation line” means a cut, perforation, score, or tear which demarcates the place where two adjoining parts (e.g., sheaths) can be separated; and

“sheath” means a structure that is designed to temporarily, and at least partially, surround another item until the item is removed therefrom.

### BRIEF DESCRIPTION OF THE DRAWINGS

FIGS. 1a and 1b are perspective views of the earplug systems 10a and 10b in accordance with the present invention;

FIG. 2 is a perspective view illustrating how a user can compress a foam earplug 12a located in a sheath 14 in accordance with the present invention;

FIG. 3 is a front view of a series of earplugs 12a disposed in a series of sheaths 14 in accordance with the present invention;

FIG. 4 is a cross-sectional view of a foam earplug 12a in a sheath 14, taken along lines 4-4 of FIG. 3, in accordance with the present invention;

FIGS. 5 and 6 are front views of earplug assemblies 36, 40 in accordance with the present invention; and

FIG. 7 is a cross-section of a series of sheaths 14 into which earplugs may be individually surrounded in accordance with the present invention.

### DETAILED DESCRIPTION OF PREFERRED EMBODIMENTS

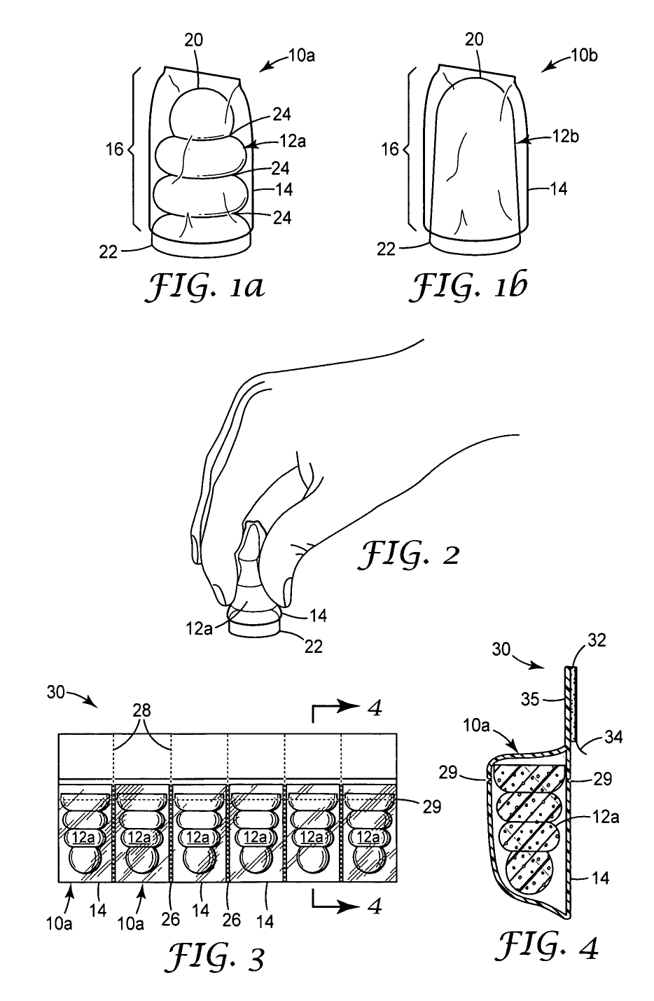

FIGS. 1a and 1b show earplug systems 10a and 10b that each comprise a foam earplug 12a, 12b and a sheath 14. Each earplug 12a and 12b has a body portion 16 and first and second ends 20 and 22. The body portion 16 is the general portion of the earplug that would be inserted into the user's ear canal. Typically, the earplug end 22 protrudes from the ear canal during use so that the user can adjust the earplug or remove it from the ear canal as needed. The body portion 16 of earplug 12a, as shown in FIG. 1a, can have a plurality of articulation zones 24 disposed between a first insertion end 20 and a second bottom end 22 to enable the earplug 12a to be bent in a variety of directions so that it can better adapt to the contours of the ear canal—see U.S. Pat. No. 6,484,726 to Remer et al. for further discussion. Alternatively, the body portion 16 of the earplug 12b can be configured in a cylindrical or bullet-like shape as shown in FIG. 1b. Each earplug 12a, 12b is arranged in each sheath 14 such that the body portion axis runs generally parallel to the longer dimension of the sheath 14. When the earplugs are configured to generally decrease in diameter going from end 22 to end 20, the sheath 14 may be tapered to generally correspond to such diameter decrease. The sheath 14 may be made from a deformable material that desirably is tear resistant and transparent.

As shown in FIG. 2, the sheath 14 exhibits these deformable, tear-resistant, and transparent qualities so that the earplug can be deformed by the user into a desired compressed condition before being inserted into the ear canal. The sheath 14 protects the earplug 12a from being exposed to contaminants that may be present on the user's fingers, while at the same time allowing for the earplug 12a to be compressed into a pre-insertion condition. The deformable nature of the sheath 14 allows the user to roll the foam earplug 12a between the user's opposable digits. Any contaminants that may be present on the user's fingers would only be transferred to the sheath 14 and not to the earplug 12a. Thus, once the earplug 12a has been compressed into its desired pre-insertion condition, the ear plug 12a may be removed from the sheath 14. The user can grasp the end 22 of the compressed earplug 12a and insert the body portion 16 (FIG. 1a) into the ear canal before it expands to its generally relaxed condition. Once inserted into the ear canal, the earplug will slowly expand from the compressed condition to fill the ear canal so that it can properly attenuate noise that may be present in the ambient environment. The sheath preferably is transparent so that the user can visually witness the earplug deformation step. As the term is used in this document, “transparent” means capable of transmitting light sufficient for a person to at least generally see the object on the opposing side of the sheath. As such, the term transparent includes films that would normally be considered translucent.

FIG. 3 shows a series of earplugs 12a that are individually disposed in a plurality of transparent sheaths 14. Each sheath 14 may be separated from an adjoining sheath 14 by a seal line 26 such as a bond or weld line. Each sheath 14 also may have a separation line 28, which can be a perforation or score line. The separation line may be used in lieu of, in conjunction with, or be the same as the seal line and may be located between an adjoining sheath 14 to facilitate separation of an individual earplug system 10a from an adjoining earplug system 10a. A user therefore can individually separate an earplug system 10a from the assembly 30, just prior to use. The earplug assembly 30 may contain two, four, or more earplug systems 10a, and up to, for example, 10 to 20 earplug systems. The earplug assemblies may also be provided in bulk form, for example, in a roll that contains up to approximately 100, 200, or 300 individual earplug systems. The desired length of the assembly could be separated from the bulk supply along one of the separation lines noted above. This smaller assembly of earplug systems could then be carried by the worker or secured to an adjacent object until use. A further discussion of earplug assemblies in bulk form is provided in copending U.S. patent application Ser. No. ______, entitled Securable Earplug Package, filed on the same day as this patent application (attorney case number 64056US002).

FIG. 3 also shows that a separation line 29 can be provided in each earplug sheath to enable the earplug 12a to be more easily removed from the sheath 14. The separation line 29 may be provided in the general region where the earplug body 16 meets end 22. As the term is used in this document, “end” does not mean precisely the outer edge of the object but includes some portion extending inwardly. In this sense, the word “end” is used in its common sense—like the “south end of town” or the “front end of a car”.

FIG. 4 shows that the sheath 14 may completely enclose the foam earplug 12a until use. In this manner of packaging, the earplugs are fully protected from contamination. FIG. 4 also shows that an earplug assembly 30 may include an adhesive layer 32 and a release liner 34. The adhesive layer 32 allows the assembly 30 to be secured to a desired location. To secure the assembly 30 to another object, the user simply removes release liner 34 and presses the adhesive layer 32 against the object by applying a force at surface 35. The adhesive can be, for example, a pressure-sensitive adhesive. Classes of suitable pressure-sensitive adhesives include acrylics, tackified rubber, tackified synthetic rubber, ethylene vinyl acetate, silicone, and the like. The adhesive may be applied directly to the earplug assembly such as with a hot-melt adhesive coating process. The adhesive may also be applied in the form of a transfer tape, using for example, Scotch™ ATG adhesive Transfer Tape 924 from the 3M Company. The earplug assembly 30 may be adhered to, for example, a worker's helmet so that the earplugs 12a are readily available for use. The earplugs 12a remain in a protective condition in each sheath 14 until the user enters an environment where the earplugs are needed. The user then can grasp an earplug system 10a from the object, separating it from the earplug assembly 30 at the separation line 28 (FIG. 3), and compressing the earplug as illustrated, for example, in FIG. 2. The sheath 14 may completely surround each earplug 12a individually to prevent it from being contaminated by any dust or contaminants that may be present in the air. A second line of separation 29 may be provided in the sheath 14 to enable it to be easily opened for purposes of removing an earplug 12a prior to insertion into the ear canal. In lieu of an adhesive layer, the assembly may include a glue, a mechanical fastener such as a hook-and-loop device, or any other suitable physical or mechanical mechanism for securing the assembly to the object.

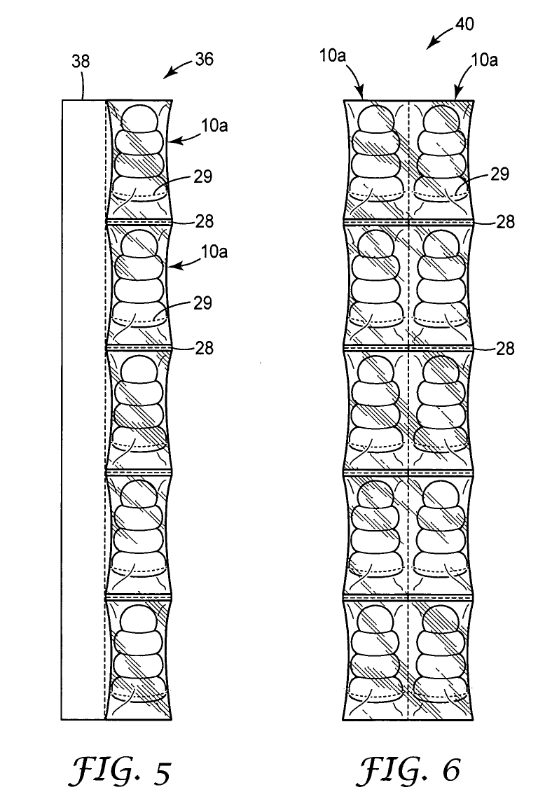

FIG. 5 illustrates an alternative arrangement of an earplug assembly 36. In this embodiment, the earplugs are disposed in the same direction as the tape portion 38 of the assembly 36. This embodiment may be preferred where a narrower earplug assembly is desired. Each earplug system 10a may be separated from an adjoining earplug system 10a by a perforation line 28, and an additional separation line 29 can be provided in each sheath to allow the earplug to be easily removed therefrom.

FIG. 6 shows yet another embodiment of an earplug assembly 40. In this embodiment, the earplug systems 10a are provided in matched pairs that are separated by separation lines 28 so that a pair of earplugs 12a can be conveniently removed at the same time. This embodiment also may include a tape, if desired, to allow the assembly 40 to be adhered to another object such as a worker's helmet. As shown in the embodiments discussed above, the adhesive and release liner may be positioned on the assembly to extend lengthwise from a first edge to a second edge. When the release liner is removed and the assembly is adhered to another object, the earplug systems drape below the tape so that they can be easily grasped by the user.

Foam earplugs of the invention may be made from a variety of materials. The earplugs may be made from prepolymers, for example, isocyanate prepolymers, polypropylene glycol, tripropylene glycol, and polyols at various ratios. Additional materials such as surfactants, stabilizers, foaming agents, and water also may be used in making foam earplugs for use in connection with the present invention. The earplug forming composition may be poured into a mold, allowed to react and/or caused to rise to produce a foam earplug suitable for use in connection with the present invention. Rising may be accomplished by any suitable means, for example by using a self-rising foam, or by heating the mold. As the foam rises, it interpenetrates into the pores of the porous component, thereby forming a mechanical bond between the porous component and the finished foam. The earplugs may include a film, coating, or skin on an outer surface of the earplug. Such film may be continuous or discontinuous and may extend around the circumference of the earplug or exist in a discrete portion or region. Generally, the foam earplugs that may be used in the present invention contain a matrix of voids or cells within a solid polymeric material. The resulting foam earplugs may contain a variety of polymers, for example, polyvinyls such as PVC, polyurethanes, viscoelastic polymers, polyethers, and combinations thereof. Examples of polymeric foam earplugs that may be used in connection with the present invention are described, for example, in the following U.S. Pat. Nos. 6,920,956 to Falco, 6,484,726 to Remer et al., 6,105,715 to Knauer, 5,799,658 to Falco, and 5,203,352 to Gardner, Jr. Externally and internally plasticized polymeric foams disclosed in U.S. Pat. No. Re. 29,487 to Ross are generally suitable for use as a material of construction for a foam earplug. These plasticized polymeric foams are slow recovery foams that are not only comfortable but tend to deliver high-in-field noise protection at various hearing frequencies. U.S. Pat. No. 5,203,352 to Gardner discloses temperature-dependent viscoelastic polymeric foam materials, which comprise a slow recovery polymer and a faster recovery polymer. Another suitable foam is described in U.S. Pat. No. 5,420,381 to Gardner, Jr. Further, U.S. Pat. No. 5,792,998 to Gardner, Jr. et al. discloses a dynamically stiff foam material that has a low static stiffness and a high dynamic stiffness. The foam component can have a dynamic spring constant of at least about 300 pounds per inch and a dynamic loss factor of at least about 0.25. One particularly suitable dynamically stiff foam material is a polyurethane material. Additional suitable polyurethane foam formulations are disclosed in U.S. Pat. No. 4,158,087 to Wood.

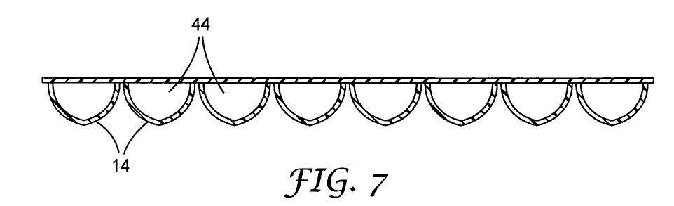

The sheath material that is used in connection with the present invention may comprise various films, sheets, foils, or formed materials. Such materials may include paper sheets, coated paper sheets, metallic foils, and a wide variety of polymeric materials, including elastomeric, rubber (e.g., nitrile or isoprene), or other plastic films or sheets. Polymeric materials may be extruded films, blown films, cast films, and films subjected to an orientation process. Polymers also can be formed into sheath structures using well-known processes such as injection molding, profile extrusion molding, and coating processes. Preferably, the sheath material provides transparency so that the user can see the earplug to facilitate its proper compression. The sheath also may comprise a polymeric film that contains one or more layers of polymeric materials. The sheath is deformable but also is resistant to being easily torn when subjected to shear forces from rolling and twisting between a user's fingers. Typically, the sheath material will exhibit a tensile modulus of less than about 10 Giga Pascals (GPa) and greater than about 1 Mega Pascal (MPa); more typically a tensile modulus of less than about 1 GPa and greater than about 100 MPa. The sheath material typically has a thickness of about 0.2 mils (5 micrometers (μm)) to about 20 mils (508 μm), more typically, about 0.5 mils (13 μm) to about 10 mils (254 μm). The sheath volume typically is about 1 to 14 cubic centimeters (cm³), more typically about 2 to 12 cm³, and still more typically about 3 to 6 cm³. The sheath volume typically is about 5 to 200% greater than the earplug volume, more typically about 10 to 100% (or 15 to 50%) greater than the earplug volume. The sheath volume is measured as the volume of the whole sheath before being opened at separation line 29 (FIGS. 3 and 4). The sheaths may be made into a corrugated-type shape (see FIG. 7) using known procedures—see, for example, U.S. Pat. No. 5,961,778 to Braun.

### EXAMPLES

### Example 1

An earplug system was created in the following manner. Two polymer film sheets were cut. The first piece was 2½ inches tall (6.35 cm) and 6 inches long (15.24 cm). The second piece was 1½ inches tall (3.81 cm) and 6 inches long (15.24 cm). The polymer film consisted of three layers: the center layer was an elastomeric material, and two outer layers were polypropylene. Both pieces were perforated using a rotary perforating tool approximately 1 inch (2.54 cm) from the bottom edge. Vertical welds were made, starting at the edge, at 1 inch intervals producing a series of six adjoining tubes.

The tubes were welded along the bottom edge to create individual pockets for the earplugs. A perforation was made along each of the vertical weld lines from the bottom edge to the horizontal perforation point. A 3M™ 1120 earplug was compressed and inserted into each pocket. A final weld was made along the top edge of the smaller piece of polyethylene to contain earplugs. A strip of transfer adhesive with release liner was applied to the back side near the top edge to create an earplug assembly similar to the assembly shown in FIG. 3.

### Example 2

An earplug assembly was prepared by cutting a sheet of a thin polymer film into a piece 5 inches long (12.7 cm) and 2 inches tall (5.08 cm). A second sheet was cut into a piece 9 inches (22.86 cm) long and 2 inches (5.08 cm) tall. The polymer film consisted of three layers: the center layer was an elastomeric material, and two outer layers were polypropylene. Each sheet was perforated, using a rotary perforating tool, in a horizontal line the entire length of each sheet, 1¼ inches (3.18 cm) from the bottom edge.

One side edge of the 5 inch (12.7 cm)×2 inch (5.1 cm) piece of material was aligned with one side edge of the 9 inch (22.9 cm)×2 inch (5.1 cm) piece of material and a ⅛ inch (3.2 mm) wide vertical heat weld was made attaching the edges together. The vertical weld extended approximately 1⅜ inches (3.5 cm). Eight additional vertical welds were made between the material pieces to form loops in the following manner. The 9 inch (22.9 cm)×2 inch (5.1 cm) piece of material was gathered at 1¼ inch (3.2 cm) intervals, placed on the 5 inch (12.7 cm)×2 inch (5.1 cm) piece of material at ⅝ inch (1.6 cm) intervals and welded. This procedure produced a looping structure of sheath pockets 44 as illustrated in FIG. 7 when viewed from the long edge.

3M™ 1120 Earplugs were first compressed and then inserted into each of the pockets until the back (second) end 22 of the earplug was generally aligned with the perforation line 29. Another heat weld was made along the entire bottom edge to produce a package similar to the assembly shown in FIGS. 3 and 4.

A final heat weld was made perpendicular to the nine vertical weld lines, above the back ends of the earplugs to enclose the earplugs. A strip of transfer adhesive with release liner was attached to one side of the earplug system, across the length of the package, above the horizontal perforation line. The top of the package was folded between the weld line and the edge of the transfer adhesive to form a more compact package. Cuts were made down the center of each vertical weld from the bottom edge up to the perforation line.

The release liner was removed and the earplug assembly was attached to the side of a hard hat. A single earplug in a sheath was grabbed with one hand and pulled until it separated along the perforation line. The earplug was compressed while still contained in the sheath using thumb and fingers. The earplug was then removed from the sheath with the other hand and inserted in the ear using standard practice.

This invention may take on various modifications and alterations without departing from its spirit and scope. Accordingly, this invention is not limited to the above-described but is to be controlled by the limitations set forth in the following claims and any equivalents thereof.

This invention also may be suitably practiced in the absence of any element not specifically disclosed herein.

All patents and patent applications cited above, including those in the Background section, are incorporated by reference into this document in total. To the extent there is a conflict or discrepancy between the disclosure in such incorporated document and the above specification, the above specification will control.

What is claimed is:

1. An earplug system that comprises:
(a) a foam earplug; and
(b) a deformable sheath that individually surrounds at least the body of the foam earplug in a noncompressed condition so as to allow the earplug to be compressed with a person's fingers while in the deformable sheath.

2. The earplug system of claim 1, wherein the deformable sheath comprises a transparent polymeric material that has a tensile modulus of 1 MPa to 10 GPa and has a thickness of 0.2 mils to 20 mils.

3. The earplug system of claim 1, wherein the deformable sheath comprises a transparent polymeric material that has a tensile modulus of 100 MPa to 1 GPa and has a thickness of 0.5 mils to 10 mils.

4. The earplug system of claim 1, wherein the deformable sheath comprises a transparent polymeric material and has a volume of about 2 to 12 cm³.

5. The earplug system of claim 4, wherein the deformable sheath has a volume of about 3 to 6 cm³.

6. The earplug system of claim 1, wherein the earplug comprises a first insertion end and an opposing second bottom end and a body portion, and wherein the sheath comprises a plastic material that has a separation line located therein at a location corresponding to where the body portion of the earplug generally meets the second bottom end.

7. The earplug system of claim 1, wherein the sheath comprises a transparent polymeric material and has a volume is about 5 to 200% larger than the volume of the earplug.

8. The earplug system of claim 7, wherein the sheath is longer in a direction extending parallel to an axis of the body portion, the earplug being arranged in the sheath such that the body portion axis is generally parallel to the longer dimension of the sheath.

9. The earplug system of claim 8, wherein the earplug comprises a first insertion end and an opposing second bottom end and a body portion, and wherein the sheath comprises a transparent plastic that has a separation line located therein at a location corresponding to where the body portion of the earplug generally meets the second bottom end.

10. An earplug assembly that comprises at least a plurality of earplug systems of claim 1 joined together.

11. An earplug assembly that comprises at least a plurality of earplug systems of claim 7 joined together.

12. The earplug assembly of claim 11, wherein the earplug systems are separated by a separation line.

13. The earplug assembly of claim 11, wherein a seal line is located between the earplug systems.

14. The earplug assembly of claim 12, comprising 4 to 20 earplug systems.

15. The earplug assembly of claim 12, comprising 10 to 300 earplug systems.

16. The earplug assembly of claim 15, comprising 20 to 200 earplug systems.

17. The earplug assembly of claim 12, wherein the separation line comprises a perforation.

18. An earplug assembly that comprises at least a plurality of earplug systems of claim 7, wherein the earplug systems are separated by a separation line.

19. The earplug assembly of claim 18, wherein the volume of each sheath is 10 to 100% larger than the volume of the earplugs.

20. The earplug assembly of claim 18, further comprising a means for securing the assembly to an object.

21. The earplug assembly of claim 18, wherein the securing means includes an adhesive and a release liner.

22. The earplug assembly of claim 21, wherein the adhesive and release liner extend lengthwise along the earplug assembly such that when the release liner is removed and the assembly is adhered to another object as intended, the earplug systems drape below the adhesive.

23. A method of making a foam earplug suitable for sound attenuation for a person, which method comprises:
(a) providing an earplug system of claim 1;
(b) compressing the foam earplug with fingers while at least the body is disposed in the sheath;
(c) removing the compressed foam earplug from the sheath; and
(d) inserting the compressed foam earplug into the ear canal.

24. A method of making a foam earplug suitable for sound attenuation for a person, which method comprises:
(a) providing an earplug assembly of claim 18;
(b) separating an earplug system from the assembly;
(c) compressing the foam earplug with fingers while at least the body is disposed in the sheath;
(d) removing the compressed foam earplug from the sheath; and
(e) inserting the compressed foam earplug into the ear canal.
